(19) United States
(12) Patent Application Publication
(10) Pub. No.: US 2007/0084851 A1
(43) Pub. Date: Apr. 19, 2007

(54) Heatable serving container with heating portion and heating element

(76) Inventors: John Pisano, Murrieta, CA (US); Ron Bishop, Murrieta, CA (US)

Correspondence Address: TOPE-MCKAY & ASSOCIATES, 23852 PACIFIC COAST HIGHWAY #311, MALIBU, CA, 90265, US

(21) Appl. No.: 11/251,406

(22) Filed: Oct. 14, 2005

(51) Int. Cl. F27D 11/00

(52) U.S. Cl. 219/433

(57) ABSTRACT

A heatable serving container with a heating portion is described. The container includes a first container and a second container. The first container is formed to be placed against a heating module and hold a heatable food product (e.g., chip dip) therein. The second container is formed to hold a food product therein. The heating module may be placed in a space formed proximate the first container and the second container may be placed upon the heating module, thereby forming the heatable serving container. When the heating module is placed against the first container, the first container is heated and thereby heats the fluid therein.

### BACKGROUND OF THE INVENTION

(1) Field of Invention

The present invention relates to a heatable serving container, and more particularly to a container having a plurality of compartments for placing various food products, with at least one of the compartments having a heating mechanism for heating a food product therein.

(2) Description of Related Art

Food serving containers have long been known in the art and include items such as bowls, trays, platters, etc. When using such a container, a user typically stores a food product within the container. It is sometimes desirable to heat a food product by placing the food product in a serving container and then heating the serving container and the food product together. For example, a user desiring to heat a chip dip would place a serving of dip in a bowl and then place the bowl in an over (either convention or microwave type) to heat the chip dip in the bowl. However, removing the bowl and heated chip dip from the oven results in the chip dip losing its heat and cooling down, thereby requiring the user to re-heat the chip dip if the chip dip is to be kept warm.

To solve this problem, containers have been devised that include a heating mechanism. For example, nacho cheese containers exist that include a heating element that heats and maintains the temperature of nacho cheese therein. A problem with typical heating containers, however, is that they are formed integrally with the heating element and therefore are difficult to clean. Additionally, existing heating containers are formed to hold only the product that is to be heated and do not accommodate another (non-heated) food product, such as chips.

Thus, a continuing need exists for a heated serving container that is easy to clean; that allows a user to heat a first food product; and that accommodates a second food product.

### SUMMARY OF INVENTION

The present invention relates to a heatable serving container with heatable portion. The heatable serving container comprises a first container formed to be placed against a heating module and hold a heatable food product therein; and a second container formed to hold a food product therein, whereby when the heating module is placed against the first container, the first container is heated and thereby heats the heatable food product therein.

In another aspect, the present invention further comprises a heating module.

In yet another aspect, the second container is formed such that it includes space for placement of the heating module.

In another aspect, the second container is substantially ring-shaped with a hole formed through its center, the hole being formed of sufficient size to allow for placement of the heating module therein and for placement of the first container upon the heating module.

In yet another aspect, the second container has a first side and a second side, with a plurality of compartments formed in the first side for placing various food items in each of the plurality of compartments.

Additionally, the second container includes an indentation on the second side, the indentation formed such that a heating module with a power cord may be placed in the hole, with the power cord positioned within the indentation to pass from the heating module to an peripheral portion of the second container.

Furthermore, the plurality of compartments are defined by at least one ridge on the first side, with the ridge forming the indentation on the second side.

In another aspect, both the first and second containers are formed of ceramic.

Additionally, both the first and second containers are formed as two separate objects, so that the heating module may be placed in the space formed in the first container and the second container may be placed upon the heating module, thereby forming the heatable serving container.

In yet another aspect, the first and second containers are integrally formed as a single object.

Finally, as can be appreciated by one in the art, the present invention also comprises a method for forming and using the heatable serving container described herein.

### BRIEF DESCRIPTION OF THE DRAWINGS

The objects, features and advantages of the present invention will be apparent from the following detailed description of the various aspects of the invention in conjunction with reference to the following drawings, where:

FIG. 1 is a perspective-view illustration of a heatable serving container according to the present invention, showing a first container, a second container, and a heating module;

FIG. 2 is a perspective-view illustration of a heatable serving container according to the present invention, showing the second container placed around the heating module with the first container placed upon the heating module;

FIG. 3 is a perspective-view illustration of a heatable serving container according to the present invention, where the first and second containers are integrally formed as a single object;

FIG. 4 is a top-view illustration of a heatable serving container according to the present invention; and

FIG. 5 is a top-view illustration of another aspect of a heatable serving container according to the present invention.

### DETAILED DESCRIPTION

The present invention relates to a heated serving container, and more particularly to a container having a plurality of compartments for placing various food products, with at least one of the compartments having a heating mechanism for heating a food product therein. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description of Specific Aspects

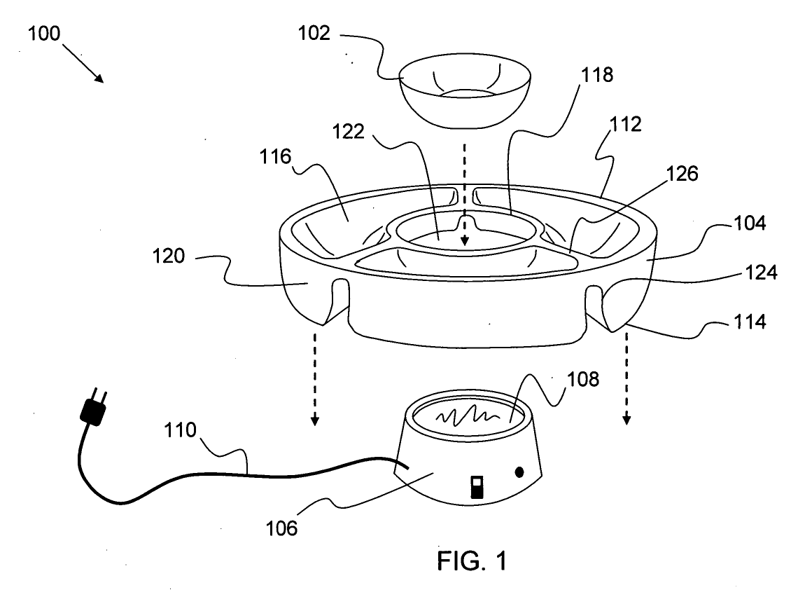

As shown in FIG. 1, the present invention relates to a heatable serving container 100. The heatable serving container 100 is formed to heat a fluid, while also holding another food product. As a non-limiting example, the heatable serving container 100 can be used as a chip and dip holder, where the dip is heated and the chips are contained proximate the heated dip for ease of access.

The heatable serving container 100 includes at least two containers, a first container 102 and a second container 104. The first 102 and second 104 containers are formed of any suitably durable material, non-limiting examples of which include plastic, metal, and ceramic. The first container 102 is formed to be placed against a heating module 106 and hold a food product (e.g., fluid) therein. The first container 102 can include a single compartment or a plurality of compartments for placement of various food products for heating. By placing the first container 102 against the heating module 106 (when the heating module 106 is turned on), the first container 102 is heated and thereby heats the food product. Non-limiting examples of such a food product include a chip dip, salsa, nacho cheese, etc.

The heating module 106 is any suitable mechanism or device for heating a surface upon which a container can be placed. As a non-limiting example, the heating module includes a hot plate 108 (such as those used in mug warmers) with a power cord 110 for powering and thereby heating the hot plate 108. Although the heating module is described herein as including a power cord 110, it is not intended to be limited thereto as one skilled in the art can appreciate that the heating module can also be powered via a battery or other portable power source (e.g., flames, chemicals, etc.).

The second container 104 is formed to hold a food product therein. The second container 104 has a first side 112 and a second side 114, with at least one compartment 116 formed in the first side 112 for the placement of the food product. The food product is any edible or potable item, non-limiting examples of which include chips, vegetables, dip, and water. In another aspect, a plurality of compartments 116 are formed in the first side 112. Various food items can be placed in each of the plurality of compartments 116.

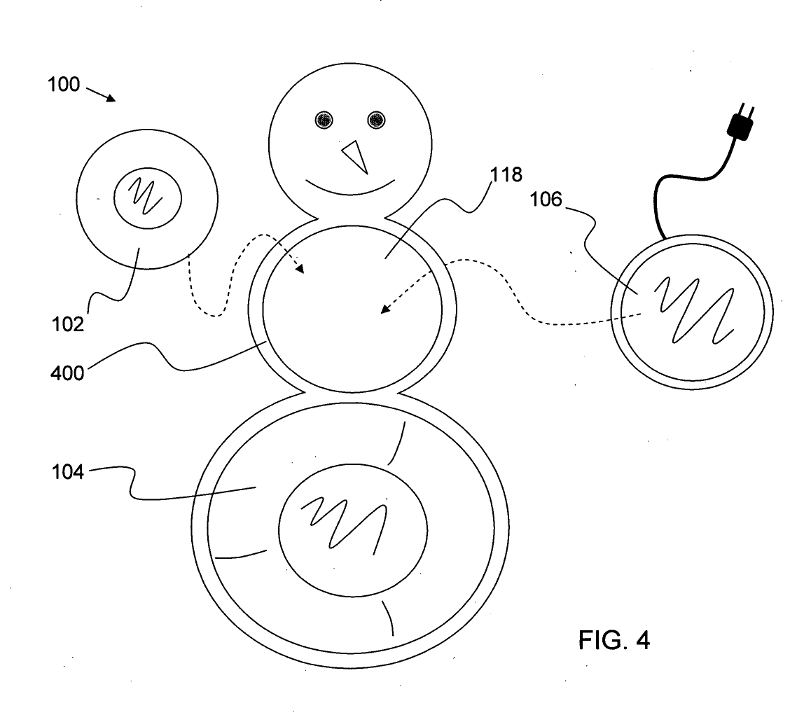

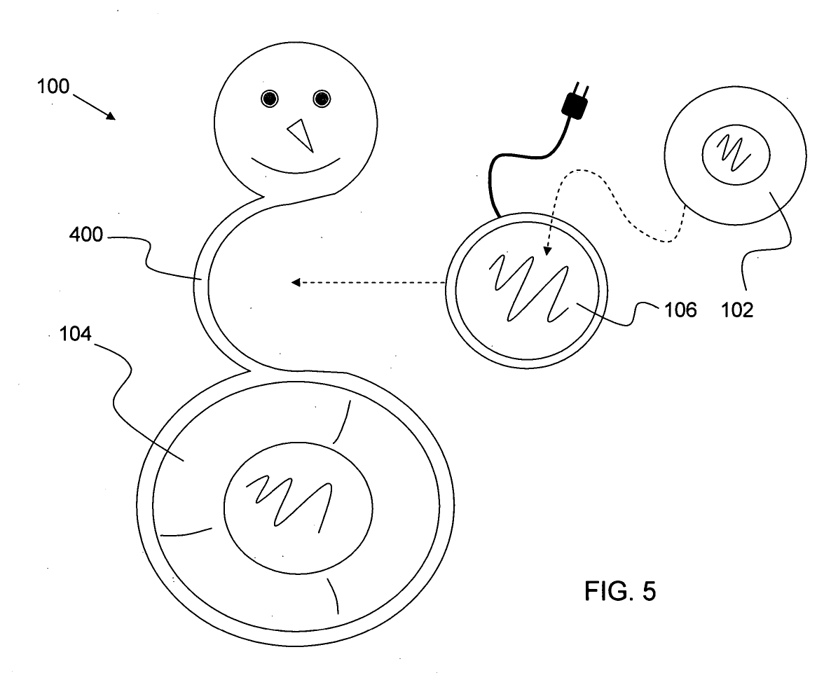

The second container 104 is formed such that when the first container 102 is placed upon the heating module 106, the first container 102 is held proximate the second container 104. In this aspect, the second container 104 includes a space 118 for placement of the heating module 106. The space 118 may be formed within the second container 104 (through it) or as a peripheral portion 120 (as shown in FIGS. 4 and 5) of the second container 104. As a non-limiting example, the second container 104 is substantially ring-shaped with a hole 122 formed through its center. The hole 122 operates as the space 118 and is formed of sufficient size to allow for placement of the heating module 106 therein, with placement of the first container 102 upon the heating module 106. As can be appreciated by one in the art, the second container 104 is not intended to be limited to a ring-shaped container and can be formed in any suitable shape to accommodate a food product and the space 118 for placement of the heating module 106 and first container 102. Additionally, although the hole 122 (i.e., space 118) is shown as being formed in the center of the second container 104, it is not intended to be limited thereto and can be formed at any suitable location so as to be near the second container 104.

In another aspect, the second container 104 includes an indentation 124 on the second side 114. The second container 104 and indentation 124 are formed such that a heating module 106 with a power cord 110 may be placed in the hole 122, with the power cord 110 positioned within the indentation 124 to pass from the heating module 106 to the peripheral portion 120 of the second container 104.

Formation of the indentation 124 on the second side 114 causes the formation of a ridge 126 on the first side 112. When present, the plurality of compartments 116 are defined by the ridge 126, allowing for the placement of various food products in the multiple compartments 116.

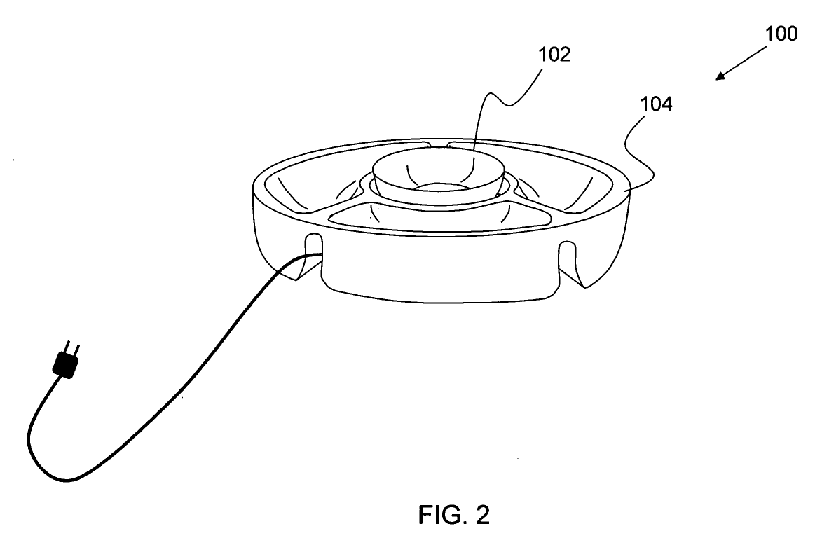

In one aspect, both the first 102 and second 104 containers are formed as two separate objects. In this aspect, the heating module 106 may be placed in the space 118, with the second container 104 thereafter placed upon the heating module 106, thereby forming the heatable serving container 100 shown in FIG. 2.

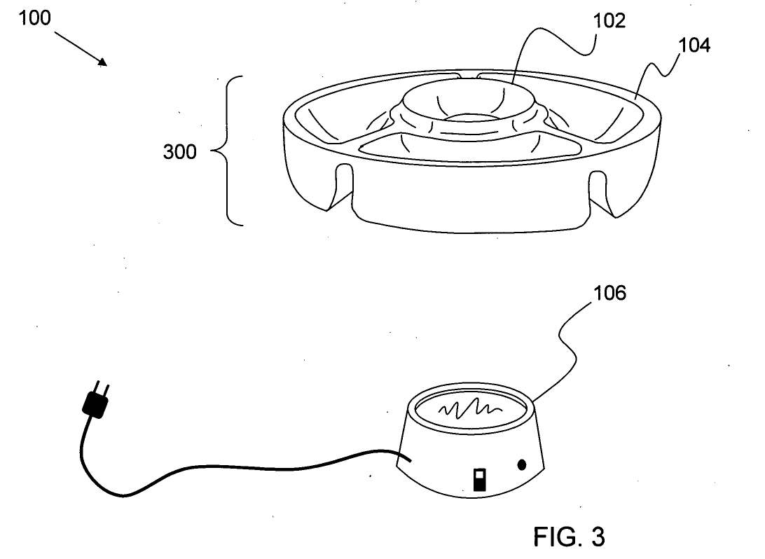

In another aspect and as shown in FIG. 3, both the first 102 and second 104 containers are integrally formed as a single object 300. In this aspect, the single object 300 is simply placed upon the heating module 106 to form the heatable serving container 100.

As shown in FIG. 4, the first 102 and second 104 containers can be formed in any suitable shape, so long as each container is formed to hold a food product therein.

Additionally, as shown in FIG. 4, the space 118 for placement of the heating module 106 can be formed at any suitable location proximate the second container 104. As a non-limiting example, the second container 104 has a frame 400 which extends out to form the space 118 adjacent to the first container 104.

The space 118 can be completely enclosed as shown in FIG. 4, or as a side-connecting space as shown in FIG. 5. For example, in the side-connecting aspect, the heating module 106 can be slid into the frame 400, with the first container 102 thereafter placed onto the heating module 106. As can be appreciated by one skilled in the art, there are numerous configurations for forming the first container 102, second container 104, and frame 400 to hold heat the first container 102 proximate the second container 104.

In another aspect, the first container 102 is formed of a heat conductive material and the second container 104 is formed at least partially of a non-conductive material. To resist the conduction of heat, a layer of non-conductive material is formed with the second container 104.

In yet another aspect, the present invention can include multiple heating elements so that food products can be heated and maintained at different temperatures in different containers.

What is claimed is:

1. A heatable serving container with heatable portion, comprising:
a first container formed to be placed against a heating module and hold a heatable food product therein; and
a second container formed to hold a food product therein, whereby when the heating module is placed against the first container, the first container is heated and thereby heats the heatable food product therein.

2. A heatable serving container with heatable portion as set forth in claim 1, further comprising a heating module.

3. A heatable serving container with heatable portion as set forth in claim 2, wherein the second container is formed such that it includes space for placement of the heating module.

4. A heatable serving container with heatable portion as set forth in claim 3, wherein the second container is substantially ring-shaped with a hole formed through its center, the hole being formed of sufficient size to allow for placement of the heating module therein and for placement of the first container upon the heating module.

5. A heatable serving container with heatable portion as set forth in claim 4, wherein the second container has a first side and a second side, with a plurality of compartments formed in the first side for placing various food items in each of the plurality of compartments.

6. A heatable serving container with heating portion as set forth in claim 5, wherein the second container includes an indentation on the second side, the indentation formed such that a heating module with a power cord may be placed in the hole, with the power cord positioned within the indentation to pass from the heating module to an peripheral portion of the second container.

7. A heatable serving container with heating portion as set forth in claim 6, wherein the plurality of compartments are defined by at least one ridge on the first side, with the ridge forming the indentation on the second side.

8. A heatable serving container with heating portion as set forth in claim 7, wherein both the first and second containers are formed of ceramic.

9. A heatable serving container with heating portion as set forth in claim 8, wherein both the first and second containers are formed as two separate objects, so that the heating module may be placed in the space formed in the first container and the second container may be placed upon the heating module, thereby forming the heatable serving container.

10. A heatable serving container with heating portion as set forth in claim 8, wherein the first and second containers are integrally formed as a single object.

11. A heatable serving container with heating portion as set forth in claim 2, wherein the second container is substantially ring-shaped with a hole formed through its center, the hole being formed of sufficient size to allow for placement of the heating module therein and for placement of the first container upon the heating module.

12. A heatable serving container with heating portion as set forth in claim 2, wherein the second container includes an indentation on the second side, the indentation formed such that a heating module with a power cord may be placed in the hole, with the power cord positioned within the indentation to pass from the heating module to an peripheral portion of the second container.

13. A heatable serving container with heating portion as set forth in claim 2, wherein both the first and second containers are formed as two separate objects, so that the heating module may be placed in the space formed in the first container and the second container may be placed upon the heating module, thereby forming the heatable serving container.

14. A heatable serving container with heating portion as set forth in claim 1, wherein the second container is formed such that it includes space for placement of the heating module.

15. A heatable serving container with heating portion as set forth in claim 1, wherein the second container has a first side and a second side, with a plurality of compartments formed in the first side for placing various food items in each of the plurality of compartments.

16. A heatable serving container with heating portion as set forth in claim 15, wherein the plurality of compartments are defined by at least one ridge on the first side, with the ridge forming the indentation on the second side.

17. A heatable serving container with heating portion as set forth in claim 1, wherein both the first and second containers are formed of ceramic.

18. A heatable serving container with heating portion as set forth in claim 1, wherein the first and second containers are integrally formed as a single object.

19. A heatable serving container with heatable portion, comprising:
a heating module;
a first container formed to be placed against the heating module and hold a heatable food product therein;
a second container formed to hold a food product therein, wherein the second container is formed such that it includes space for placement of the heating module, whereby when the heating module is placed in the space and the first container is placed upon the heating module, the first container is heated and thereby heats the heatable food product therein.

20. A heatable serving container with heatable portion as set forth in claim 19, wherein the second container is substantially ring-shaped with a hole formed through its center, the hole being formed of sufficient size to allow for placement of the heating module therein and for placement of the first container upon the heating module, wherein the second container has a first side and a second side, with a plurality of compartments formed in the first side for placing various food items in each of the plurality of compartments, and wherein the second container includes an indentation on the second side, the indentation formed such that a heating module with a power cord may be placed in the hole, with the power cord positioned within the indentation to pass from the heating module to an peripheral portion of the second container, and wherein the plurality of compartments are defined by at least one ridge on the first side, with the ridge forming the indentation on the second side.
